(19) United States
(12) Patent Application Publication
(10) Pub. No.: US 2025/0262982 A1
(43) Pub. Date: Aug. 21, 2025

(54) BATTERY REUSE MANAGEMENT SYSTEM

(71) Applicant: TOYOTA JIDOSHA KABUSHIKI KAISHA, Toyota-shi (JP)

(72) Inventors: Masahiro KAGAMI, Nagoya-shi (JP); Kenji Zaitsu, Nagoya-shi (JP); Yasuhide Kurimoto, Kasugai-shi (JP)

(73) Assignee: TOYOTA JIDOSHA KABUSHIKI KAISHA, Toyota-shi (JP)

(21) Appl. No.: 18/947,452

(22) Filed: Nov. 14, 2024

(30) Foreign Application Priority Data
Feb. 19, 2024 (JP) 2024-022653

(51) Int. Cl. B60L 58/16; B60L 58/12; H01M 10/42; H01M 10/54

(52) U.S. Cl. CPC B60L 58/16; B60L 58/12; H01M 10/425; H01M 10/54; H01M 2010/4278

(57) ABSTRACT

A battery reuse management system includes a stationary electrical storage device and an information management apparatus. The stationary electrical storage device includes a plurality of in-vehicle battery packs at least one or some of which have been primarily used. The information management apparatus is configured to receive, from the stationary electrical storage device, battery management information on each of the plurality of in-vehicle battery packs and manage the battery management information. The battery management information includes travel distance information indicating a total travel distance that a vehicle has travelled when a corresponding one of the in-vehicle battery packs is mounted on the vehicle. The information management apparatus is configured to execute a pack identification process of identifying the in-vehicle battery pack corresponding to the battery management information based on the travel distance information.

### CROSS-REFERENCE TO RELATED APPLICATION

This application claims priority to Japanese Patent Application No. 2024-022653 filed on Feb. 19, 2024, incorporated herein by reference in its entirety.

### BACKGROUND

### 1. Technical Field

The disclosure relates to a technology to manage the reuse of an in-vehicle battery pack.

### 2. Description of Related Art

WO 2012/043592 describes a power supply unit including a plurality of function modules and a main controller. Each of the function modules includes a battery block made up of a plurality of battery cells, a communication interface, a memory unit, and a battery status detecting unit. When a function module is connected to the main controller, unique address information is assigned to the function module from the main controller. The function module records the assigned unique address information in the memory unit and performs data communication based on the address information.

WO 2002/067347 describes a battery pack including unique address and a communication device to a network so that the battery pack itself can connect with the network. Japanese Unexamined Patent Application Publication No. 2017-175858 (JP 2017-175858 A) describes a storage battery management apparatus that, at a startup of an electrical storage system, detects that a battery pack is attached and assigns a management number for identifying the battery pack.

### SUMMARY

When a battery reuse management system includes a stationary electrical storage device including a plurality of in-vehicle battery packs at least partially primarily used and an information management apparatus that receives, from the stationary electrical storage device, battery management information on each of the in-vehicle battery packs and manages the battery management information, the battery reuse management system has the following task. It is desirable that a correspondence between battery management information transmitted from the stationary electrical storage device to the information management apparatus and an in-vehicle battery pack not become unknown.

A battery reuse management system according to the disclosure includes a stationary electrical storage device and an information management apparatus. The stationary electrical storage device includes a plurality of in-vehicle battery packs at least one or some of which have been primarily used. The information management apparatus is configured to receive, from the stationary electrical storage device, battery management information on each of the plurality of in-vehicle battery packs and manage the battery management information. The battery management information includes travel distance information indicating a total travel distance that a vehicle has travelled when a corresponding one of the in-vehicle battery packs is mounted on the vehicle. The information management apparatus is configured to execute a pack identification process of identifying the in-vehicle battery pack corresponding to the battery management information based on the travel distance information.

When in-vehicle battery packs have been primarily used in vehicles, travel distance information when each in-vehicle battery pack is primarily used is unique to the in-vehicle battery pack. Even when the in-vehicle battery pack is reused in a stationary electrical storage device thereafter, the travel distance information remains unchanged from that when the in-vehicle battery pack is primarily used. For this reason, with the use of travel distance information, it is possible to make it easy to identify an in-vehicle battery pack corresponding to battery management information from the stationary electrical storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for illustrating a general outline of a battery reuse management system according to an embodiment;

FIG. 2 is a conceptual diagram for illustrating information related to the reuse of an in-vehicle battery pack;

FIG. 3 is a block diagram that shows a configuration example of an information management apparatus and a battery use system;

FIG. 4 is a diagram for specifically illustrating a task related to identification of an in-vehicle battery pack corresponding to battery management information; and

FIG. 5 is a flowchart that shows an example of a process related to association (re-association) of an in-vehicle battery pack with a communication instrument having an unknown MAC address.

### DETAILED DESCRIPTION OF EMBODIMENTS

An embodiment of the disclosure will be described with reference to the accompanying drawings.

### 1. Battery Reuse Management System

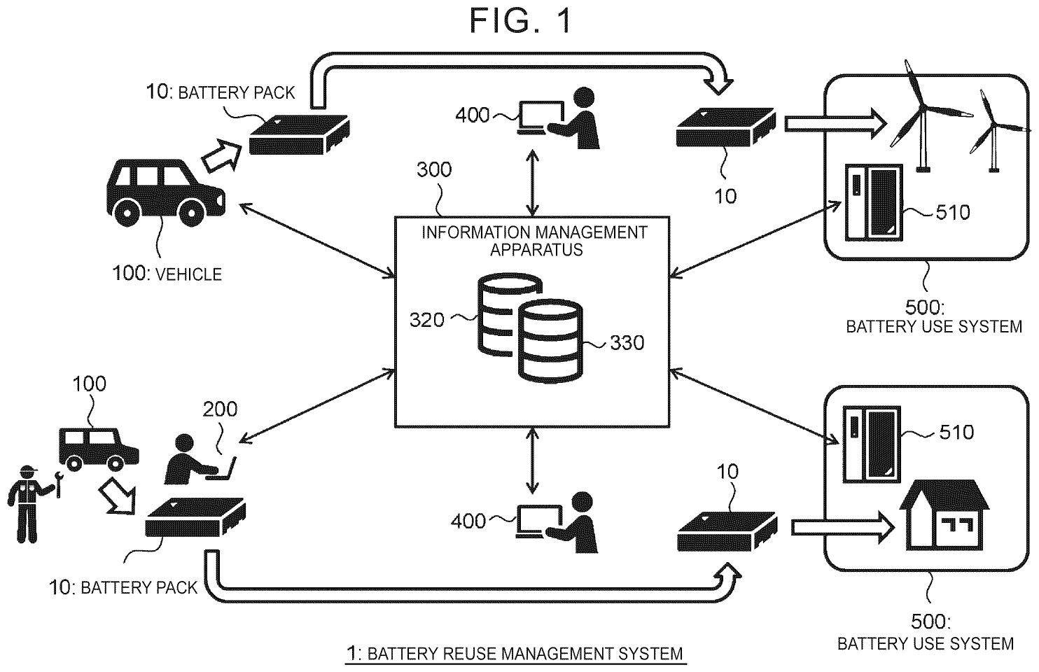

FIG. 1 is a conceptual diagram for illustrating a general outline of a battery reuse management system 1 according to the present embodiment. The battery reuse management system 1 manages the reuse of a battery pack 10. Reuse is a concept including secondary use, tertiary use, . . . . Particularly, the battery reuse management system 1 manages the reuse of the battery pack (in-vehicle battery pack) 10 mounted on a vehicle 100. The vehicle 100 is a battery electric vehicle (BEV) or a hybrid electric vehicle (HEV or PHEV) that uses an electric motor as a driving power unit. The battery pack 10 is mounted on the vehicle 100. The electric motor is driven by electric power supplied from the battery pack 10.

The battery reuse management system 1 includes one or more vehicles 100 and an information management apparatus 300. The information management apparatus 300 serves as an information platform that manages various pieces of information. The information management apparatus 300 includes one or more servers. The information management apparatus 300 may be made up of a plurality of servers that execute distributed processing. Each vehicle 100 and the information management apparatus 300 are communicable with each other via a wireless communication network.

The vehicle 100 may periodically transmit vehicle information on the vehicle 100 to the information management apparatus 300. The vehicle information may include travel history information TRV indicating the travel history of the vehicle 100. For example, the travel history information TRV includes a total travel distance of the vehicle 100. In another example, the travel history information TRV may include location history information of the vehicle 100.

The vehicle information may include battery information BAT reflecting a usage history of the battery pack 10. For example, the battery information BAT includes battery usage history information. The battery usage history information includes, for example, at least one of a temperature history, a state-of-charge (SOC) history, a current history, a voltage history, and a charge history. Each history may be expressed by a frequency distribution. The battery information BAT may include a state of health (SOH).

The SOH may be calculated based on battery usage history information. The battery information BAT may include a total charge electricity amount and/or a total discharge electricity amount. The battery information BAT may include a battery capacity and/or a battery output.

The battery reuse management system 1 may further include a terminal 200 that is used at a vehicle dealer or a vehicle repair factory. At a vehicle dealer or a vehicle repair factory, the above-described vehicle information can be read from the vehicle 100 with a predetermined tool. The vehicle information read from the vehicle 100 is input to the terminal 200. In other words, the terminal 200 can also acquire the vehicle information. The terminal 200 is communicable with the information management apparatus 300 via a wireless or wired communication network. The terminal 200 may transmit vehicle information read from the vehicle 100 to the information management apparatus 300.

The information management apparatus 300 collects, accumulates, and manages vehicle information on a large number of vehicles 100. The information management apparatus 300 includes a vehicle information database 320 that accumulates vehicle information on a large number of vehicles 100. The vehicle information database 320 is implemented by one or more storage devices.

Next, the reuse of the battery packs 10 that have been mounted on the vehicles 100 will be described. The battery packs 10 are taken out from the vehicles 100 and reused.

A battery use system 500 is a system that uses a storage battery. For example, the battery use system 500 is a stationary storage battery system that accumulates renewable energy in a stationary storage battery. In another example, the battery use system 500 may be a home power supply system using a stationary storage battery. According to the present embodiment, the battery packs (in-vehicle battery packs) 10 that have been mounted on the vehicles 100 are reused as a stationary electrical storage device 520 (described later) in such a battery use system 500. A large number of battery packs 10 are provided from a large number of vehicles 100, so cost reduction of the battery use system 500 is facilitated, and proliferation of the battery use system 500 is facilitated.

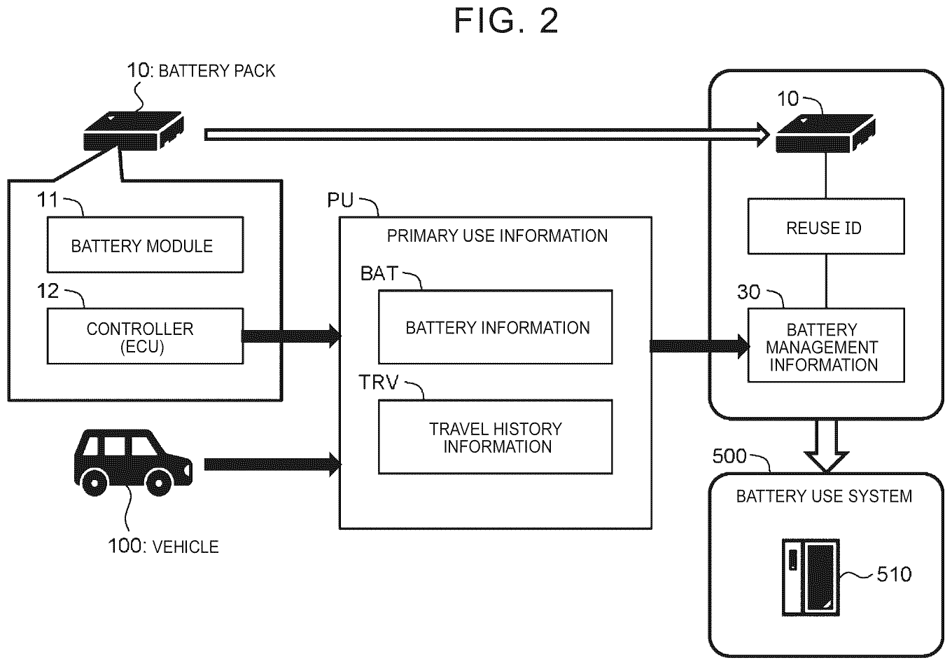

FIG. 2 is a conceptual diagram for illustrating information related to the reuse of the battery pack 10. The battery pack 10 includes one or more battery modules 11 and a controller 12 for controlling the battery pack 10. The controller 12 is also called electronic control unit (ECU).

In reusing the battery pack 10, the battery reuse management system 1 acquires primary use information PU. The primary use information PU corresponds to vehicle information when the battery pack 10 is primarily used in the vehicle 100.

For example, the primary use information PU includes battery information BAT reflecting the usage history of the battery pack 10 primarily used in the vehicle 100. The battery information BAT is stored in the controller 12 (ECU) in the battery pack 10 and is read from the controller 12. For example, just before the battery pack 10 is taken out from the vehicle 100, an information processing device of the vehicle 100 acquires the battery information BAT from the controller 12 in the battery pack 10 and transmits the battery information BAT to the information management apparatus 300. In another example, at a vehicle dealer or a vehicle repair factory, the battery information BAT may be read from the controller 12 (ECU) in the battery pack 10 with a predetermined tool. In this case, the terminal 200 acquires the battery information BAT, and transmits the battery information BAT to the information management apparatus 300. In another example, the information management apparatus 300 may acquire the battery information BAT of the vehicle 100 from the vehicle information database 320.

The primary use information PU may include travel history information TRV of the vehicle 100 on which the battery pack 10 has been mounted. The travel history information TRV includes travel distance information indicating a total travel distance of the vehicle 100. The travel history information TRV may also include location history information. The total travel distance information is stored in the controller 12 in the battery pack 10 or a storage device of an in-vehicle system. The location history information is obtained from the storage device of the in-vehicle system or the vehicle information database 320 of the information management apparatus 300. The information management apparatus 300 acquires the travel history information TRV with a method similar to the above-described method of acquiring the battery information BAT.

Battery management information 30 is information that is used when the battery pack 10 is reused. The battery management information 30 is generated based on the primary use information PU. More specifically, the battery management information 30 includes the battery information BAT and the travel history information TRV. There are various environments (ambient temperature, humidity, and the like) of regions where the vehicle 100 has travelled, and the degradation condition of battery performance varies depending on an environment, so the travel history information TRV can also be useful information when the battery pack 10 is reused. The battery management information 30 may include the vehicle type of the vehicle 100 on which the battery pack 10 has been mounted. The battery management information 30 may be generated in any one of the vehicle 100, the terminal 200, and the information management apparatus 300.

The information management apparatus 300 collects, accumulates, and manages pieces of battery management information 30 on a large number of vehicles 100. The information management apparatus 300 includes a battery management information database 330 that accumulates the pieces of battery management information 30 on a large number of vehicles 100 (see FIG. 1). The battery management information database 330 is implemented by one or more storage devices.

Reuse identification information (hereinafter, referred to as “reuse ID”) is identification information of the battery pack 10 reused. The details of the reuse ID will be described later. The reuse ID is associated with the battery pack 10. For example, a peel-off sticker or the like with printed two-dimensional code indicating the reuse ID is attached to the battery pack 10. QR code (registered trademark) is illustrated as two-dimensional code. More specifically, at a vehicle dealer or a vehicle repair factory, an operator takes out the battery pack 10 from the vehicle 100. A reuse ID is generated by the terminal 200 or the operator. The operator attaches a peel-off sticker or the like with printed two-dimensional code indicating the reuse ID to the battery pack 10. The terminal 200 associates the reuse ID with the primary use information PU or the battery management information 30 and transmits the reuse ID and the primary use information PU or the battery management information 30 to the information management apparatus 300.

In this way, the information management apparatus 300 acquires the reuse ID and the battery management information 30 of the battery pack 10. The information management apparatus 300 associates the reuse ID with the battery management information 30 in the battery management information database 330. In other words, the information management apparatus 300 manages the reuse ID and the battery management information 30 in association with each other.

The battery pack 10 taken out from the vehicle 100 is provided to a user that reuses the battery pack 10 (hereinafter, referred to as “reuse user” or “reuser”). The reuse user is an operator of the battery use system 500. The information management apparatus 300 provides the reuse ID and the battery management information 30 to the reuse user in association with each other. In other words, a set of three pieces, that is, the battery pack 10, the reuse ID of the battery pack 10, and the battery management information 30 on the battery pack 10, are provided to the reuse user. In other words, the battery pack 10 and the battery management information 30 are associated with the reuse ID and provided to the reuse user.

More specifically, the battery use system 500 includes an information collecting apparatus 510. The information collecting apparatus 510 is communicable with the information management apparatus 300 via a wired or wireless communication network. The information management apparatus 300 transmits the reuse ID and the battery management information 30 of the battery pack 10 to the information collecting apparatus 510 of the battery use system 500 in which the battery pack 10 is reused. The information collecting apparatus 510 manages the reuse ID and the battery management information 30 in association with each other. On the other hand, two-dimensional code indicating the reuse ID of the battery pack 10 is attached to the battery pack 10. Therefore, in the battery use system 500, the battery pack 10, the reuse ID, and the battery management information 30 are associated with one another.

When the battery pack 10 is reused in the battery use system 500, the information collecting apparatus 510 monitors the status of use of the battery pack 10 and adds battery usage history information on the battery pack 10 to the battery management information 30 (battery information BAT). As a result, the battery management information 30 includes not only the battery information BAT when the battery pack 10 is primarily used in the vehicle 100 but also the battery information BAT when the battery pack 10 is reused in the battery use system 500. In this way, the battery usage history information reflects not only the usage history of the battery pack 10 when primarily used in the vehicle 100 but also the usage history of the battery pack 10 when reused.

The information collecting apparatus 510 periodically uploads (transmits) the latest battery management information 30 to the information management apparatus 300 together with the reuse ID. The information management apparatus 300 periodically acquires the latest battery management information 30 and the reuse ID. The information management apparatus 300 updates the battery management information 30 associated with the reuse ID in the battery management information database 330 with the latest one.

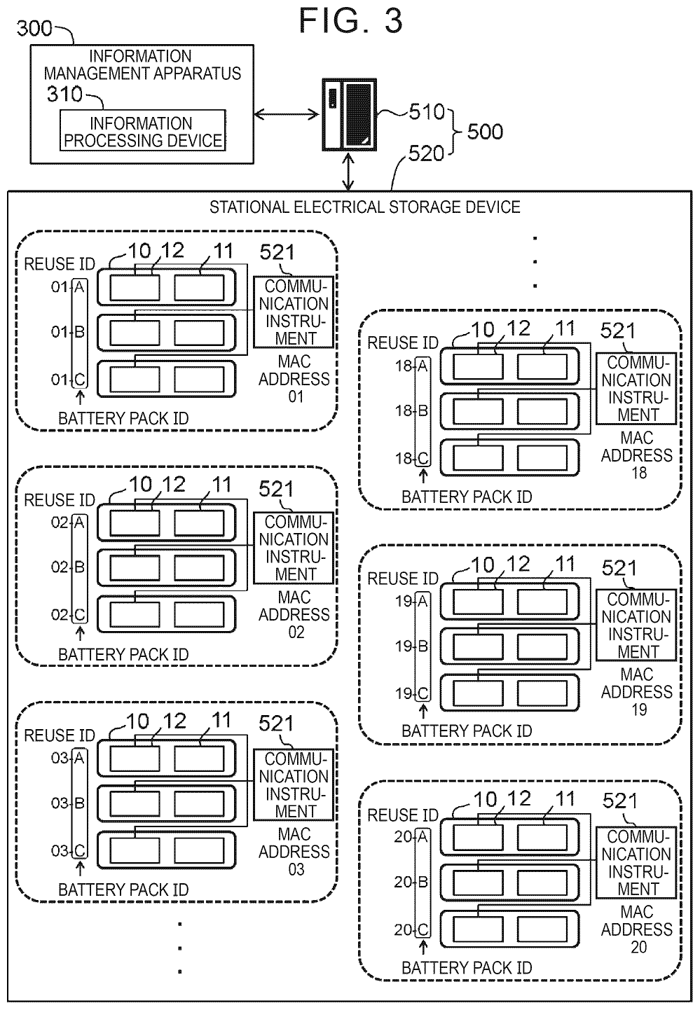

FIG. 3 is a block diagram that shows a configuration example of the information management apparatus 300 and the battery use system 500.

The information management apparatus 300 includes an information processing device 310 in addition to the vehicle information database 320 and the battery management information database 330 (see FIG. 1). The information processing device 310 is allowed to access the vehicle information database 320 and the battery management information database 330. The information processing device 310 stores various pieces of information, executes various pieces of information processing, and communicates with external sources via a communication interface. The information processing device 310 includes one or more processors (processing circuits) and one or more storage devices. The functions of the information processing device 310 may be implemented by cooperation of the processor(s) running a control program with the storage device(s). The control program is stored in the storage device(s). Alternatively, the control program may be recorded on a computer-readable recording medium.

The battery use system 500 includes the stationary electrical storage device 520 together with the information collecting apparatus 510. The stationary electrical storage device 520 is made up of a combination of a plurality of the battery packs 10. At least one or some of the battery packs 10 included in the stationary electrical storage device 520 have been primarily used, that is, at least one or some of the battery packs 10 included in the stationary electrical storage device 520 are used products that have been mounted on the vehicle 100 and used. For example, all the battery packs 10 included in the stationary electrical storage device 520 may have been primarily used.

In an example shown in FIG. 3, the stationary electrical storage device 520 includes 60 battery packs 10. Specifically, the 60 battery packs 10 are configured as 20 sets of battery packs 10 in total where three battery packs 10 are configured as one set. The stationary electrical storage device 520 includes a plurality of communication instruments 521. The communication instrument 521 is also called a dongle. In the stationary electrical storage device 520, one communication instrument 521 is provided for one set of three battery packs 10. In other words, each of the 20 communication instruments 521 is associated with the plurality of (for example, three) battery packs 10 in one set. Each of the communication instruments 521 is communicably connected to the controller 12 included in each of the corresponding battery packs 10.

In order to monitor the statuses of use of all the battery packs 10 included in the stationary electrical storage device 520, the information collecting apparatus 510 communicates with each of the communication instruments 521, acquires the pieces of battery usage history information of the battery packs 10 in each set, and updates the pieces of battery management information 30. As already described above, the information collecting apparatus 510 transmits the latest battery management information 30 to the information management apparatus 300 together with the reuse ID. In other words, each of the communication instruments 521 transmits the pieces of battery management information 30 and the reuse IDs of the three battery packs 10 associated with itself to the information management apparatus 300 via the information collecting apparatus 510. This transmission is performed for each individual battery pack 10.

In the present embodiment, the reuse ID (reuse identification information) is determined as follows. A unique address is assigned to each communication instrument 521. The address is a media access control address (MAC address). Specifically, MAC addresses 01 to 20 are respectively assigned to the 20 communication instruments 521 included in the stationary electrical storage device 520. For the sake of convenience of description, the MAC addresses are expressed by two-digit numerals shorter than actual MAC addresses. Then, battery pack IDs (pack identification information) are assigned to all the battery packs 10 included in the stationary electrical storage device 520. Specifically, battery pack IDs A, B, and C are respectively assigned to the three battery packs 10 in each set. In other words, battery pack IDs do not overlap among the three battery packs 10 associated with the same communication instrument 521 and are numbered in accordance with a common rule on an individual communication instrument 521 basis. Then, as shown in FIG. 3, the reuse ID is a combination (for example, 01-A) of the MAC address (for example, 01) of the communication instrument 521 with the battery pack ID (for example, A) of the battery pack 10 associated with the communication instrument 521.

### 2. Identifying Battery Pack Corresponding to Battery Management Information

In the battery reuse management system 1, it is desirable that a correspondence between the battery management information 30 transmitted from the stationary electrical storage device 520 to the information management apparatus 300 and the battery pack (in-vehicle battery pack) 10 not become unknown. In other words, the information management apparatus 300 is desired to be capable of easily identifying the battery pack 10 corresponding to the battery management information 30 transmitted from the stationary electrical storage device 520.

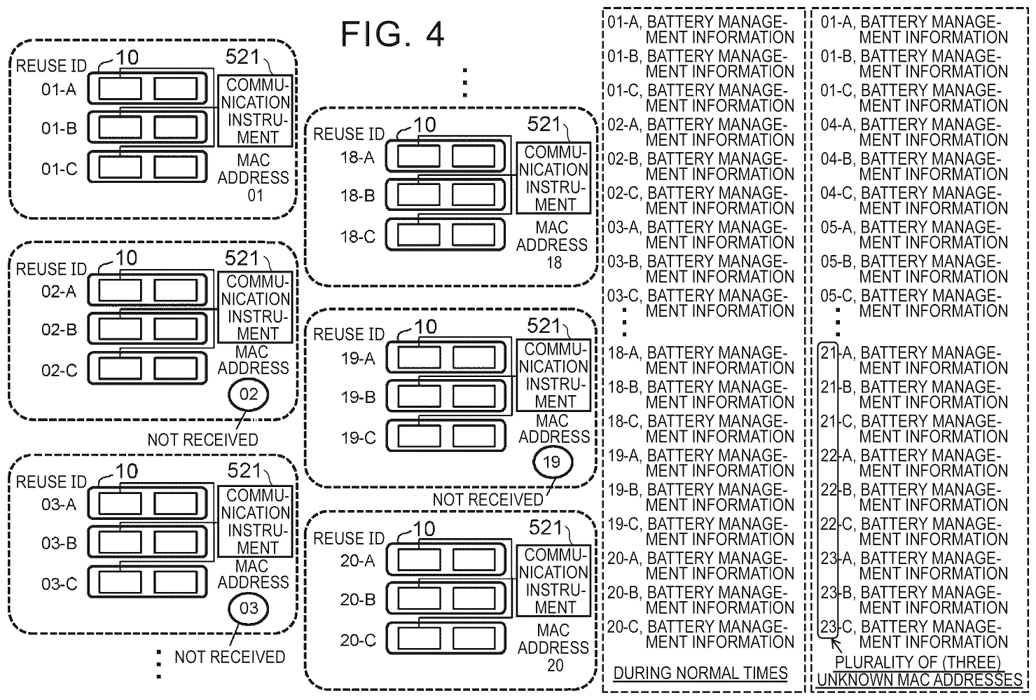

FIG. 4 is a diagram for specifically illustrating a task related to identification of the battery pack 10 corresponding to the battery management information 30. In FIG. 4, as in the case of the example shown in FIG. 3, the stationary electrical storage device 520 including 20 sets of one communication instrument 521 and three battery packs 10 is illustrated.

In FIG. 4, “during normal times” corresponds to when, for all the battery packs 10, combinations of the reuse ID and the battery management information 30, held by the information management apparatus 300, are transmitted from the stationary electrical storage device 520 to the information management apparatus 300 via the information collecting apparatus 510.

On the other hand, when a plurality of communication instruments 521 has been replaced for reasons, such as failure, after the last transmission of the pieces of battery management information 30, pieces of battery management information 30 received by the information management apparatus 300 include pieces of battery management information 30 on battery packs 10 to which the reuse IDs (such as 21-A) including the MAC addresses of the communication instruments 521 after replacement are assigned. The MAC addresses of the communication instruments 521 after replacement are unknown MAC addresses for the information management apparatus 300.

If the number of communication instruments 521 having an unknown MAC address is one, it may be determined that the communication instrument 521 having a MAC address included at the last transmission of the battery management information 30 and not received this time has been replaced with the communication instrument 521 having the unknown MAC address. In this case, the information management apparatus 300 updates the reuse IDs such that three battery packs 10 associated with the communication instrument 521 having a MAC address not received this time are associated with the communication instrument 521 having the unknown MAC address. Thus, the information management apparatus 300 can continuously identify the three battery packs 10 with the updated reuse IDs. Then, the information management apparatus 300 can continuously acquire the pieces of battery management information 30 of the three battery packs 10 by associating the updated reuse IDs with the pieces of battery management information 30 of the three battery packs 10.

On the other hand, when, for example, a plurality of the communication instruments 521 is replaced at the same time, the reuse IDs transmitted from the stationary electrical storage device 520 include six or more reuse IDs each having an unknown MAC address. If the number of unknown MAC addresses becomes two or more in this way, it is not possible to identify which unknown MAC addresses correspond to which two or more MAC addresses not received this time. In other words, it is not possible to identify the battery packs 10 to which the reuse IDs including these unknown MAC addresses are assigned. More specifically, FIG. 4 shows an example in which three unknown MAC addresses 21, 22, 23 are included. In this example, it is necessary to take measures for identifying a correspondence between three MAC addresses 02, 03, 19 not received this time and three unknown MAC addresses 21, 22, 23.

Then, in the present embodiment, the information management apparatus 300 executes a pack identification process. The pack identification process is a process of identifying the battery pack 10 corresponding to the battery management information 30 based on travel distance information. The travel distance information used in the pack identification process is included in the battery management information 30 received from the stationary electrical storage device 520 for each individual battery pack 10.

Specifically, in the pack identification process, when the MAC addresses of the plurality of communication instruments 521, received from the stationary electrical storage device 520, include a plurality of unreceived MAC addresses and a plurality of unknown MAC address as many as the plurality of unreceived MAC addresses, the information management apparatus 300 identifies the plurality of unknown MAC addresses respectively corresponding to the plurality of unreceived MAC addresses based on travel distance information. Then, the information management apparatus 300 associates the battery packs 10 that have been respectively associated with the plurality of communication instruments 521 having the plurality of unreceived MAC addresses with the plurality of communication instruments 521 having the plurality of unknown MAC addresses identified.

In the pack identification process, when it is not possible to identify a plurality of unknown MAC addresses respectively corresponding to a plurality of unreceived MAC addresses based on travel distance information, the information management apparatus 300 performs the identification based on battery usage history information.

### 2-1. Example of Process

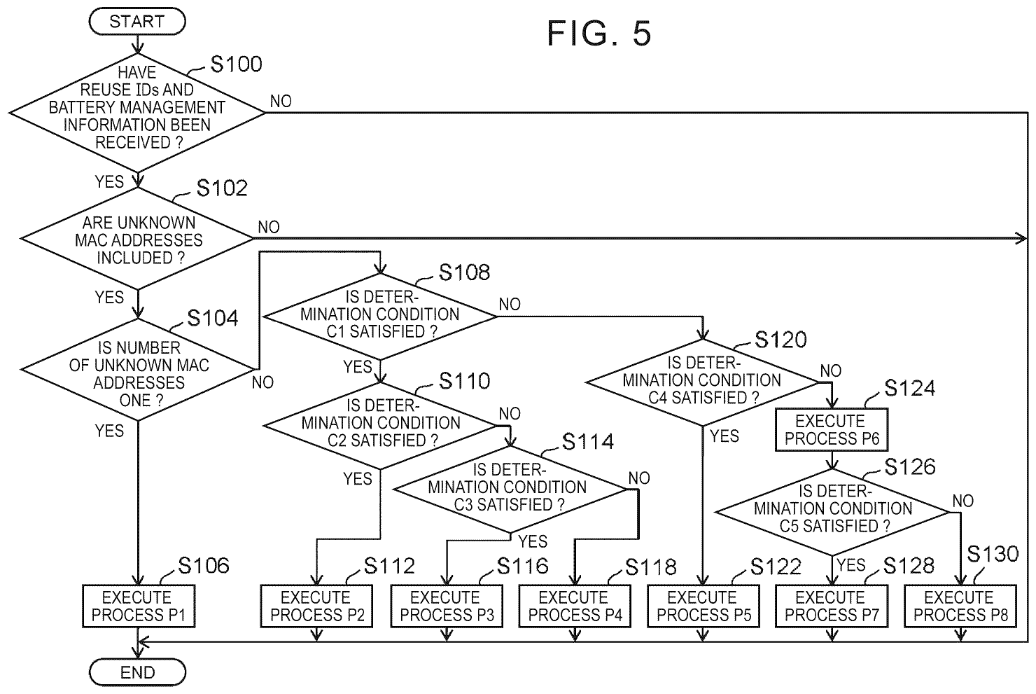

FIG. 5 is a flowchart that shows an example of a process related to association (re-association) of battery packs 10 with communication instruments 521 having unknown MAC addresses. Processes P1, P2, P3, P4, P5, P6, P7, P8 in FIG. 5 each are a process related to re-association of battery packs 10 and are included in the pack identification process.

In step S100, the information processing device (or simply the device) 310 of the information management apparatus 300 determines whether information (reuse ID and battery management information 30) on each individual battery pack 10 from the stationary electrical storage device 520 has been received. More specifically, the information is received in order of the battery pack IDs of A, B, and C for each communication instrument 521. When the received information includes unknown MAC addresses (Yes in step $102), the process proceeds to step S104.

In step S104, the device 310 determines whether the number of unknown MAC addresses is one. As a result, when the number of unknown MAC addresses is one, the device 310 executes the process PI (step S106). In the process P1, the device 310 cancels the reuse IDs including the MAC address not received this time and updates (re-associates) the reuse IDs of the three battery packs 10, to which the cancelled reuse IDs have been assigned, with reuse IDs including a MAC address newly received this time. For example, when the MAC address 02 is not received and the MAC address 21 is newly received, the reuse IDs of the three battery packs 10, to which the reuse IDs 02-A, 02-B, and 02-C are assigned, are updated with the reuse IDs 21-A, 21-B, and 21-C.

On the other hand, when the number of unknown MAC addresses is two or more (No in step S104), the device 310 determines whether a determination condition C1 is satisfied (step S108). In the following description, for the sake of convenience, the battery packs 10 having the battery pack IDs of A, B, and C are respectively referred to as battery packs 10A, 10B, 10C.

The determination condition C1 is that, of the battery packs 10 associated with two or more MAC addresses not received this time, the number of the battery packs 10A of which the total travel distance at the last reception is zero is one or zero. The travel distance information includes the numeric value of the total travel distance of the battery pack 10 not primarily used in the vehicle 100 (that is, a new battery pack 10) as zero.

When the determination condition C1 is satisfied, the device 310 determines whether a determination condition C2 is satisfied (step S110). The determination condition C2 is that the numeric values of the total travel distances of the battery packs 10A respectively associated with the two or more MAC addresses not received this time all are different. When the determination condition C2 is satisfied, the device 310 executes the process P2 (step S112).

In the process P2, the device 310 refers to the travel distance information included in the battery management information 30 of each of the intended battery packs 10. Specifically, the device 310 searches for pairs in which the total travel distance matches between the battery packs 10A associated with the MAC addresses not received this time and the battery packs 10A associated with the unknown MAC addresses newly received this time. The number of pairs is equal to the number of MAC addresses not received this time and also equal to the number of unknown MAC addresses. For each searched pair, the device 310 updates (re-associates) the reuse IDs such that the MAC address not received this time is replaced with the MAC address newly received this time. When, for example, the total travel distances of three battery packs 10A having the MAC addresses of 02, 03, and 19 not received this time are respectively X, Y, and Z and the total travel distances of battery packs 10A having unknown MAC addresses 21, 22, and 23 are respectively Y, X, and Z, re-association is performed as follows. The MAC address of 02 is replaced with 22, 03 is replaced with 21, and 19 is replaced with 23.

On the other hand, when the determination condition C2 is not satisfied, that is, when the numeric values of the total travel distances overlap among the battery packs 10A associated with MAC addresses not received this time, the device 310 determines whether a determination condition C3 is satisfied (step S114). The determination condition C3 is that a combination of the numeric values of the total travel distances of the battery packs 10B, 10C associated with each individual MAC address not received this time is different among two or more MAC addresses not received this time. When the determination condition C3 is satisfied, the device 310 executes the process P3 (step S116). For example, the determination condition C3 is satisfied when combinations of the numeric values of the total travel distances of the three sets of battery packs 10B, 10C, respectively associated with three MAC addresses 02, 03, and 19 not received this time, are respectively “Y and Z”, “V and W”, and “Z and V”.

In the process P3, the device 310 searches for pairs in which a combination of the total travel distances of the battery packs 10B, 10C associated with the MAC address not received this time matches a combination of the total travel distances of the battery packs 10B, 10C associated with the unknown MAC address newly received this time. For each searched pair, the device 310 updates (re-associates) the reuse IDs such that the MAC address not received this time is replaced with the unknown MAC address newly received this time. When, for example, the combinations of the numeric values of the total travel distances of the sets of battery packs 10B, 10C, respectively associated with the unknown MAC addresses of 21, 22, and 23, are respectively “V and W”, “Y and Z”, and “Z and V”, re-association is performed as follows. The MAC address of 02 is replaced with 22, 03 is replaced with 21, and 19 is replaced with 23.

When the determination condition C3 is not satisfied, that is, when the combinations of the numeric values of the total travel distances of the sets of battery packs 10A, 10B, 10C overlap among the MAC addresses not received this time, the device 310 executes the process P4 (step S118). Initially, for the battery packs 10B, 10C of which the combinations of the numeric values of the total travel distances do not overlap among the MAC addresses not received this time, the process P4 is the same as the process P3. Then, for the battery packs 10A, 10B, 10C of which the combinations of the numeric values of the total travel distances overlap, the device 310 uses the battery usage history information (in other words, a battery load history) for re-association. In other words, the device 310 uses at least one (for example, at least one of a temperature history, an SOC history, a current history, a voltage history, and a charge history) of the battery usage history information included in the battery management information 30.

Specifically, the device 310 searches for pairs in which continuity in the at least one history of the battery usage history information is recognized between the battery management information 30 at the last reception for the battery packs 10A, 10B, 10C associated with the MAC address not received this time and the battery management information 30 at the current reception for the battery packs 10A, 10B, 10C associated with the unknown MAC address newly received this time. Whether continuity in history is recognized can be determined based on, for example, whether an amount of change of the value of history at the current reception from the value of history at the last reception is less than or equal to a predetermined threshold. Then, for the searched pair as a target (more specifically, for each searched pair when there is a plurality of searched pairs), the device 310 updates the reuse IDs such that the MAC address not received this time is replaced with the unknown MAC address newly received this time. In addition, when each history included in the battery usage history information is expressed by frequency distribution, the frequency of each segment (for example, in the temperature history, a temperature of 30° C. to 31° C., 31°° C. to 32° C., 32° C. to 33° C., . . . ) of the frequency distribution monotonously increases every predetermined period of time. For this reason, when data of the frequencies of the MAC addresses not received this time is compared with data of the frequencies of the MAC addresses newly received this time, it is impossible that the numeric values of all the segments in the history (for example, at least one of the temperature history, the SOC history, the current history, and the charge history) reduce. Focusing on this point, it is possible to identify the battery packs 10 by considering the frequency added to the history in an elapsed time from the last reception of the battery management information 30 to the current reception of the battery management information 30.

In FIG. 5, when the determination condition C1 is not satisfied, that is, when the number of the battery packs 10A of which the total travel distance at the last reception is zero is two or more among the battery packs 10 associated with two or more MAC addresses not received this time, the device 310 determines whether a determination condition C4 is satisfied (step S120). The determination condition C4 is the same as the determination condition C3. When the determination condition C4 is satisfied, the device 310 executes the process P5 (step S122). The process P5 is the same as the process P3.

On the other hand, when the determination condition C4 is not satisfied, that is, when the combinations of the numeric values of the total travel distances of the battery packs 10A, 10B, 10C overlap among the MAC addresses not received this time, the device 310 executes the process P6 (step S124) and executes the process P7 (step S128) or the process P8 (step S130) according to whether the determination condition C5 (step $126) is satisfied.

Specifically, for the battery packs 10B, 10C of which the combinations of the numeric values of the total travel distances do not overlap among the MAC addresses not received this time, the process P6 that is the same as the process P3 is executed. In addition, even when two or more of the battery packs 10A associated with two or more MAC addresses not received this time are new but when the combinations of the numeric values of the total travel distances of the battery packs 10B, 10C managed by the same MAC addresses of those battery packs 10A are different among the MAC addresses, re-association is easy.

On the other hand, for the battery packs 10A, 10B, 10C of which the combinations of the numeric values of the total travel distances overlap, the process P7 or the process P8 is executed according to whether the determination condition C5 is satisfied. The determination condition C5 is that all the battery packs 10A, 10B, 10C having the overlap combinations of the numeric values of the total travel distances on an individual MAC address not received this time basis are new. The process P7 that is executed when the determination condition C5 is satisfied is similar to a process that uses battery usage history information for re-association in the process P4. More specifically, even when all the battery packs 10A, 10B, 10C intended for identification are new, various histories (for example, at least one of the temperature history, the current history, and the SOC history) are different on an individual battery pack 10 basis according to a difference in the installation location of the individual battery pack 10 in the stationary electrical storage device 520. For this reason, focusing on this point, even when the determination condition C5 is satisfied, re-association is possible.

The process P8 that is executed when the determination condition C5 is not satisfied (that is, when the battery packs 10 having the overlap combinations of the numeric values of the total travel distances on an individual MAC address basis include primarily used battery packs 10) is a process that uses battery usage history information for re-association similarly to the process P4 for primarily used battery packs 10. More specifically, when the determination condition C5 is not satisfied, it is easy to perform re-association by using battery usage history information by focusing on primarily used battery packs 10 (that is, the battery packs 10 each having a total travel distance (a numeric value other than zero) and actually used in the vehicle 100).

In addition, the information management apparatus 300 (information processing device 310) associates the pieces of battery management information 30, associated with the reuse IDs before update, with the reuse IDs updated in the process P1, the process P2, the process P3, the process P4, the process P5, the process P6, the process P7, or the process P8 shown in FIG. 5.

### 2-2. Advantageous Effects

When the battery pack 10 is primarily used in the vehicle 100, travel distance information when the battery pack 10 is primarily used is unique to each battery pack 10. Even when the battery pack 10 is reused in the stationary electrical storage device 520 thereafter, the travel distance information remains unchanged as that when the battery pack 10 is primarily used. For this reason, with the use of travel distance information, it is possible to make it easy to identify the battery pack 10 corresponding to the battery management information 30 from the stationary electrical storage device 520.

More specifically, with the processes P2, P3, P5, and P6 of the flowchart shown in FIG. 5, even when a plurality of MAC addresses is not received due to replacement of a plurality of communication instruments 521, it is possible to identify the communication instruments 521 having a plurality of unknown MAC addresses (that is, the plurality of replaced communication instruments 521) with the use of the travel distance information. Then, it is possible to continuously identify the battery packs 10 associated with the communication instruments 521 having MAC addresses not received this time.

When a primarily used battery pack 10 is reused in the vehicle 100, it is considerably rare that the numeric values of the total travel distances match among the battery packs 10 included in the stationary electrical storage device 520. Furthermore, there is presumably an extremely low possibility that a combination of numeric values of the total travel distances of a plurality of battery packs 10 associated with the same communication instrument 521 overlaps among a plurality of communication instruments 521 (among a plurality of MAC addresses). Then, with the processes P4, P7, and P8 of the flowchart shown in FIG. 5, even if it is not possible to identify a plurality of unknown MAC addresses, respectively corresponding to a plurality of MAC addresses not received, based on travel distance information due to the overlap, it is possible to perform the identification with the use of the battery usage history information.

The number of battery packs 10 associated with each of the communication instruments 521 may be not multiple unlike the case of the example illustrated in FIG. 3 and may be one. However, when the number of battery packs 10 associated with each individual communication instrument 521 is one, the number of communication instruments 521 is enormous if the number of battery packs 10 included in the stationary electrical storage device 520 is large. This can lead to an increase in cost and an increase in communication load of the stationary electrical storage device 520 (first adverse effect). This can also lead to an increase in the frequency of replacement of the communication instrument 521 depending on the durability of the communication instrument 521 (first adverse effect). Conversely, it is conceivable to associate all the battery packs 10 included in the stationary electrical storage device 520 with one communication instrument 521. However, in this example, as the number of battery packs 10 increases, management of battery pack IDs is complicated (second adverse effect). In contrast, as illustrated in FIG. 3, by adopting a configuration that a plurality of battery packs 10 is associated with each of a plurality of communication instruments 521, it is possible to suppress both the first and second adverse effects. In addition, battery pack IDs (pieces of pack identification information) do not overlap among a plurality of battery packs 10 associated with the same communication instrument 521 and are numbered in accordance with a common rule on an individual communication instrument 521 basis. Therefore, it is easy to number a large number of battery packs 10 by using simple battery pack IDs as in the case of the example of A to C in FIG. 3.

### 2-3. Another Example of Reuse ID

In an example in which all the battery packs 10 included in the stationary electrical storage device 520 are primarily used battery packs 10, the reuse IDs may be travel distance information. In other words, for each individual battery pack 10, a numeric value of the total travel distance when the battery pack 10 is primarily used may be used as a reuse ID. According to this example, by using travel distance information as a reuse ID, it is possible to easily identify a battery pack 10 corresponding to battery management information 30 from the stationary electrical storage device 520. In addition, in this example, when numeric values of total travel distances used as reuse IDs overlap among a plurality of battery packs 10, the reuse IDs may include additional information, such as alphanumeric characters, to identify the plurality of battery packs 10.

What is claimed is:

1. A battery reuse management system comprising:
a stationary electrical storage device including a plurality of in-vehicle battery packs at least one or some of which have been primarily used; and
an information management apparatus configured to receive, from the stationary electrical storage device, battery management information on each of the plurality of in-vehicle battery packs and manage the battery management information, wherein:
the battery management information includes travel distance information indicating a total travel distance that a vehicle has travelled when a corresponding one of the in-vehicle battery packs is mounted on the vehicle; and
the information management apparatus is configured to execute a pack identification process of identifying the in-vehicle battery pack corresponding to the battery management information based on the travel distance information.

2. The battery reuse management system according to claim 1, wherein:
the stationary electrical storage device includes a plurality of communication instruments each associated with one or more in-vehicle battery packs included in the plurality of in-vehicle battery packs;
each of the plurality of communication instruments is configured to transmit, to the information management apparatus, the battery management information of the one or more in-vehicle battery packs associated with the communication instrument and reuse identification information for each individual in-vehicle battery pack;
the reuse identification information is identification information of each of the plurality of in-vehicle battery packs during reuse and is a combination of an address unique to each of the plurality of communication instruments with pack identification information assigned to each of the plurality of in-vehicle battery packs;
the pieces of pack identification information do not overlap among the one or more in-vehicle battery packs associated with the same communication instrument and are numbered in accordance with a common rule on an individual communication instrument basis; and
in the pack identification process, when the addresses of the plurality of communication instruments, received from the stationary electrical storage device, include a plurality of unreceived addresses and a plurality of unknown addresses as many as the plurality of unreceived addresses, the information management apparatus is configured to
identify the plurality of unknown addresses respectively corresponding to the plurality of unreceived addresses based on the travel distance information, and
respectively associate the plurality of communication instruments having the identified plurality of unknown addresses with the one or more in-vehicle battery packs respectively associated with the plurality of communication instruments having the plurality of unreceived addresses.

3. The battery reuse management system according to claim 2, wherein a plurality of the in-vehicle battery packs is associated with each of the plurality of communication instruments.

4. The battery reuse management system according to claim 2, wherein:
the battery management information includes battery usage history information reflecting a usage history of a corresponding one of the in-vehicle battery packs; and
in the pack identification process, when the information management apparatus fails to identify the plurality of unknown addresses respectively corresponding to the plurality of unreceived addresses based on the travel distance information, the information management apparatus is configured to identify the plurality of unknown addresses based on the battery usage history information.
